(19) United States
(12) Patent Application Publication
(10) Pub. No.: US 2014/0377577 A1
(43) Pub. Date: Dec. 25, 2014

(54) BLENDED POLYMER COMPOSITIONS SUITABLE FOR USE IN WIRE AND CABLE APPLICATIONS AND METHODS OF MAKING THE SAME

(71) Applicant: Equistar Chemicals, LP, Houston, TX (US)

(72) Inventors: Chun D. Lee, Cincinnati, OH (US); Harilaos Mavridis, Lebanon, OH (US); Mick C. Hundley, Loveland, OH (US)

(73) Assignee: Equistar Chemicals, LP, Houston, TX (US)

(21) Appl. No.: 14/062,419

(22) Filed: Oct. 24, 2013

Related U.S. Application Data
(60) Provisional application No. 61/837,013, filed on Jun. 19, 2013.

(51) Int. Cl. H01B 3/44; G02B 6/44; C08L 23/06

(52) U.S. Cl. CPC H01B 3/441; C08L 23/06; G02B 6/4401; C08L 2205/025; C08L 2203/202
USPC 428/523; 525/240; 524/528; 174/110 PM; 385/100

(57) ABSTRACT

Disclosed herein are blended polymer compositions having a polyethylene first resin and a mLLDPE resin. The polyethylene first resin have a density of at least 0.926 g/cm³; and the mLLDPE resin has a density of between about 0.910 to about 0.925 g/cm³ and a melt index ranging from about 0.05 to about 5. The amount of the mLLDPE is less than about 20 weight percent based on the weight of the polyethylene first resin and mLLDPE resin; and the mLLDPE resin has a narrower molecular weight distribution than the polyethylene first resin.

### CROSS-REFERENCES TO RELATED APPLICATIONS

This application claims benefit and priority of U.S. Provisional Patent Application No. 61/837,013 filed on Jun. 19, 2013, which is incorporated herein by reference in its entirety.

### FIELD OF THE INVENTION

This disclosure relates to blended polymer compositions that are suitable for use in wire and cable applications and methods of making the same. In an exemplary embodiment, this disclosure relates to blends of a polyethylene first resin and a mLLDPE resin.

### BACKGROUND OF THE INVENTION

Polyolefins, especially polyethylenes, have been manufactured using slurry, solution, and gas-phase polymerization processes and Ziegler-Natta and chromium catalysts as well as single-site metallocene catalysts. For the purposes of this disclosure, polyethylene may be divided into high density (HDPE, density 0.941 g/cm³ or greater), medium density (MDPE, density from 0.926 to 0.940 g/cm³), low density (LDPE, density from 0.910 to 0.925 g/cm³) and linear low density polyethylene (LLDPE, density from 0.910 to 0.925 g/cm³). In various embodiments used throughout this disclosure, the term “mLLDPE” means any linear low density polyethylene made by single-site catalysts including metallocene single-site catalysts.

Polyethylene has been used in commercial applications. The present disclosure is directed toward a new polyethylene blended composition that may be used as a wire or cable jacketing, sleeve or coating.

### SUMMARY OF THE INVENTION

In various embodiments herein are disclosed blended polymer compositions having a polyethylene first resin and a mLLDPE resin. The polyethylene first resin may have a density of at least 0.926 g/cm³; and the mLLDPE resin may have a density of between about 0.910 to about 0.925 g/cm³ and a melt index ranging between about 0.05 and about 5. The amount of the mLLDPE may be less than about 20 weight percent based on the weight of the polyethylene first resin and the mLLDPE resin; and the mLLDPE resin may have a narrower molecular weight distribution than the polyethylene first resin. The blended compositions may further include carbon black and other additives.

In another embodiment provided herein are jacketed wires or cables. The jacketed wire or cable may include a conductor or an optical fiber having a jacket disposed about at least a portion of the conductor or optical fiber. The jacket may comprise blended polymer compositions having a polyethylene first resin and a mLLDPE resin. The polyethylene first resin may have a density of at least 0.926 g/cm³; and the mLLDPE resin may have a density of between about 0.910 to about 0.925 g/cm³ and a melt index less than about 5. The amount of the mLLDPE may be less than about 20 weight percent based on the weight of the polyethylene first resin and the mLLDPE resin; and the mLLDPE resin may have a narrower molecular weight distribution than the polyethylene first resin. The blended compositions may further include carbon black and other additives.

### BRIEF DESCRIPTION OF THE DRAWINGS

For a further understanding of the nature and objects of the present disclosure, reference should be made to the following detailed disclosure, taken in conjunction with the accompanying drawing figures, in which like parts are given like reference numerals. The drawing figures are not necessarily to scale and certain features of various embodiments of the disclosure may be shown exaggerated in scale or in somewhat schematic form in the interest of clarity and conciseness, wherein:

FIG. 1 is a graph illustrating the percent shrinkage of resins applied to wire as tested according to the “Procedure A” defined in the example section below of Comparative resin A and B and inventive blended resins Blend A and Blend B;

FIG. 2 is a graph illustrating the percent shrinkage of resins applied to wire as tested according to the “Procedure A” defined in the example section below of Comparative resin A and B and inventive blended resins Blend D and Blend E;

FIG. 3 is a graph illustrating the NCTL ESCR (hours) of Comparative resins A and B and inventive blended resins Blend C, Blend D, and Blend E; and

FIG. 4 is a graph illustrating the critical shear rates (1/s) for on-set of melt fracture of Comparative resin A and inventive blended resins Blends A-E,

### DETAILED DESCRIPTION OF THE INVENTION

The instant disclosure is directed toward blended compositions of a polyethylene first resin and a mLLDPE. Blending methods and techniques suitable for use in connection with this disclosure are generally known. In an embodiment, the mLLDPE may be present in an amount ranging between about 0.01 wt. % and about 20 wt. %, based on the total weight of the polyethylene first resin and the mLLDPE. Optionally, the blended compositions may be formed into a jacket, sleeve, or coating to be disposed on or about, or otherwise applied to, at least a portion of a wire or cable.

In various embodiments, once the jacket, sleeve or coating is disposed on or about, or otherwise applied to, at least a portion of a wire or cable, the jacket, sleeve or coating may shrink between about 0% and about 5%, alternatively less than about 4%, alternatively less than about 3.75%, alternatively less than about 3.5%, alternatively less than about 3%, alternatively less than about 2.75%, and alternatively less than about 2.5%, as tested according to a “Procedure A” defined in the example section below. In various embodiments, the jacket, sleeve or coating may exhibit good environmental stress crack resistance (“ESCR”) as measured by notched constant tensile loading (“NCTL”). A NCTL method suitable for testing materials of the present disclosure may be to use a five notched tensile bar specimen (ASTM D1822, type “L”), loaded with 30% of yield strength (of specimen) in 10% Igepal solution at 50° C. to monitor a failure in a ESCR bath. In various embodiments, the NCTL ESCR of the inventive blends of the instant disclosure may be between about 300 hours and about 2,000 hours or more, alternatively greater than about 400 hours, alternatively greater than about 500 hours, alternatively greater than about 700 hours, alternatively greater than about 1000 hours, and alternatively greater than about 1500 hours. In still further embodiments, the jacket, sleeve or coating may exhibit good processability as measured by examination (for example visual inspection by a human) of surface quality for, or of, extrudates through, for example, capillary rheometer extrusion with different rates. Preferably, the jacket, sleeve or coating will appear free of “shark-skin” type melt fractures to the naked, human eye.

Polyethylene first resins suitable for use in the instant disclosure include LLDPE, LDPE, MDPE, HDPE, as well as copolymers of ethylene, butene, and/or hexene. The polyethylene first resin may have a density above about 0.91 g/cm³, and alternatively from about 0.926 to about 0.940 g/cm³. The polyethylene first resin may also have a melt index MI₂ (2.16 kg, 190° C.) between about 0.1 to about 10 dg/10 min, alternatively between about 0.5 to about 7 dg/10 min. The polyethylene first resin can be produced by known Ziegler-Natta catalysts or chromium catalysts. Examples of suitable Ziegler-Natta catalysts for making polyethylene first resin, such as LLDPE, include titanium halides, titanium alkoxides, vanadium halides, and mixtures thereof. Ziegler-Natta catalysts may be used with cocatalysts such as alkyl aluminum compounds.

In an embodiment, the polyethylene first resin may be Petrothene®, and optionally Petrothene® GA837091, available from Equistar Chemicals, LP located in Houston, Tex. Thus, in an embodiment the polyethylene first resin may be a broad molecular weight, medium density resin having a melt index of about 0.75 g/10 min (according to ASTM D1238, which is hereby incorporated by reference in full), a density of about 0.934 g/cm³ (according to ASTM D1505, which is hereby incorporated by reference in full), a tensile strength @ break of 20.7 MPa (according to ASTM D638, which is hereby incorporated by reference in full), a tensile stress at yield of 17.9 MPa (according to ASTM D638, which is hereby incorporated by reference in full), and an environmental stress crack resistance, 10% Iegpal® greater than 1,000 hours (according to ASTM 1693, which is hereby incorporated by reference in full). In an embodiment, the polyethylene first resin has a polydispersity index ranging between about 5 and 20, alternatively from about 6 to about 20, and alternatively from about 7 to 15.

The mLLDPE resin preferably has a density within the range of 0.880 g/cm³ to 0.944 g/cm³, and alternatively within the range of about 0.910 g/cm³ to about 0.925 g/cm³. The mLLDPE may have an MI₂ within the range of 0.05 to 50 dg/min, alternatively within the range of about 0.1 dg/min to about 10 dg/min, alternatively within the range of about 0.3 dg/min to about 5 dg/min, and alternatively about 3.5. The MI₂ may be measured according to ASTM D-1238 at 190° C. under 2.16 kg pressure. The mLLDPE may have a molecular weight distribution Mw/Mn less than 7, more preferably less than 5, and most preferably less than 3. In an embodiment, the mLLDPE has a polydispersity index ranging between about 1 and 5, alternatively from about 1 to about 4, and alternatively from about 1 to 3.

In various embodiments, the mLLDPE may be a copolymer of ethylene with 5 wt % to 15 wt % of one or more C₃-C₁₀ α-olefins, based on the total weight of the mLLDPE. Suitable α-olefins may include propylene, 1-butene, 1-pentene, 1- hexene, 4-methyl-1-pentene, and 1-octene, the like, and mixtures thereof. Preferably, the α-olefin is selected from the group consisting of 1-butene, 1-hexene, 1-octene, and mixtures thereof. In other embodiments, the mLLDPE may be a terpolymer.

Many mLLDPE resins suitable for use in the instant blended compositions are commercially available. Examples include Starflex®, and optionally Starflex® GM1835, mLLDPE from Equistar Chemicals, LP and Exceed® mLLDPE from ExxonMobil Chemicals, both located in Houston, Tex. Metallocene single-site catalysts are transition metal compounds that contain cyclopentadienyl (Cp) or Cp derivative ligands. For example, U.S. Pat. No. 4,542,199, which is hereby incorporated by reference in full, teaches metallocene catalysts.

The polyethylene first resin and the mLLDPE resin may be mixed, or blended, by any suitable mixing, or blending, technique. The polymers and optional additives can be blended in solution or in thermal processing, including for example in melt screw extrusion. Alternatively, the blended composition of the present disclosure may be made by in situ polymerization. For instance, the first component polyethylene can be prepared first and the mLLDPE can then be prepared in the presence of the first component polyethylene. For another instance, the mLLDPE can be prepared and the first component polyethylene can then be prepared in the presence of the mLLDPE.

The blended compositions may include a variety of additives. For example, in an embodiment, the blended composition may include generally available carbon black, stabilizers, and antioxidants such as Irganox 1010. In particular embodiments the blended composition may contain about 1250 PPM of Irganox 1010. In an embodiment, the blended compositions of the present disclosure may contain between 0 and 20 weight percent total additives. In another embodiment, the blended compositions of the present disclosure may contain between about 0 and about 10 weight percent carbon black, alternatively less than about 5 weight percent carbon black, and alternatively about 2.6 weight percent of carbon black, based on the weight percent of the total polymer composition. In other embodiments additives such as PM92973, which itself contains 40 weight percent carbon black, may be added in amounts less than about 15 weight percent, and alternatively about 6 weight percent.

In an embodiment, the blended compositions of the instant disclosure may be useful for making articles by injection molding, blow molding, rotomolding, and compression molding. The resins may also be useful for making films, extrusion coatings, pipes, sheets, and fibers. Products that can be made from the resins may include grocery bags, trash bags, merchandise bags, pails, crates, detergent bottles, toys, coolers, corrugated pipe, house wrap, shipping envelopes, protective packaging, wire and cable applications and many others. In an alternative embodiment, the blended compositions of the instant disclosure may be formed into a jacket, sleeve or coating for a wire or cable.

### EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

### Blend A:

A 2000 gram batch of blended resin was prepared containing: 79.4 wt % Petrothene® GA837091, 6.6 wt % of PM92973 (a commercial carbon black (CB) master batch containing 40.0 wt % CB) and 14.0 wt % Starflex GM1835® (all available from Equistar Chemicals, LP) was prepared through twin screw compounding to produce a “Blend A.” The die temperature was 200° C. during compounding. No additional additives or stabilizers were introduced.

The ESCR of Blend A was tested by NCTL. In particular, a five notched tensile bar specimen of Blend A (according to ASTM D1822, type L) was loaded with 30% of yield strength (of the specimen) in 10% Igepal solution at 50° C. The sample was then monitored for a failure in an ESCR bath.

A portion of Blend A was applied to a wire as a coating. The wire coating extrusion was conducted on a 2.5 inch Davis-Standard line using a sleeve die with 4:1 draw-down on 14 American Wire Gauge (“AWG”) wire for a 30 mil insulation thickness. The line speed was set at 400 feet/minute.

Shrinkage measurements were performed on at least a portion of the wire coated with Blend A and were obtained by the following procedure hereinafter referred to as “Procedure A”: overnight aging (for 12 hours) a 10.0 inch long wire sample (without conduct) at ambient temperature; the 10.0 inch conditioned specimen was then further aged at 100° C. for 24 hours on a bed of talc; and the shrinkage measurement was the change, if any, in insulation length from 10.0 inches.

### Blend B:

A 2000 gram batch of blended resin was prepared containing: 74.7 wt % Petrothene® GA837091, 6.6 wt % of PM92973, and 18.7 wt % % Starflex GM1835® (all available from Equistar Chemicals, LP) was prepared through twin screw compounding to produce a “Blend B.” The die temperature was 200° C. during compounding. No additional additives or stabilizers were introduced.

The ESCR of Blend A was tested by NCTL. In particular, a five notched tensile bar specimen of Blend B (according to ASTM D1822, type L) was loaded with 30% of yield strength (of the specimen) in 10% Igepal solution at 50° C. The sample was then monitored for a failure in an ESCR bath.

A portion of Blend B was applied to a wire as a coating. The wire coating extrusion was conducted on a 2.5 inch Davis-Standard line using a sleeve die with 4:1 draw-down on 14 AWG wire for a 30 mil insulation thickness. The line speed was set at 400 feet/minute.

Shrinkage measurements were performed on at least a portion of the wire coated with Blend B. The measurements were obtained by overnight aging (for 12 hours) a 10.0 inch long wire sample (without conduct) at ambient temperature. The 10.0 inch conditioned specimen was then the sample was further aged at 100° C. for 24 hours on a bed of talc. The shrinkage measurement was the changes in insulation length from 10.0 inches.

### Blend C:

A 2000 gram batch of blended resin was prepared containing: 86.9 wt % Petrothene® GA837091, 6.6 wt % of PM97973, and 6.5 wt % Starflex GM1835® (all available from Equistar Chemicals, LP) was prepared through twin screw compounding to produce a “Blend C.” The die temperature was 200° C. during compounding. No additional additives or stabilizers were introduced.

The ESCR of Blend C was tested by NCTL. In particular, a five notched tensile bar specimen of Blend C (according to ASTM D1822, type L) was loaded with 30% of yield strength (of the specimen) in 10% Igepal solution at 50° C. The sample was then monitored for a failure in an ESCR bath.

A portion of Blend C was applied to a wire as a coating. The wire coating extrusion was conducted on a 2.5 inch Davis-Standard line using a sleeve die with 4:1 draw-down on 14 AWG wire for a 30 mil insulation thickness. The line speed was set at 400 feet/minute.

Shrinkage measurements were performed on at least a portion of the wire coated with Blend C. The measurements were obtained by overnight aging (for 12 hours) a 10.0 inch long wire sample (without conduct) at ambient temperature. The 10.0 inch conditioned specimen was then further aged at 100° C. for 24 hours on a bed of talc. The shrinkage measurement was the changes in insulation length from 10.0 inches.

### Blend D:

A 2000 gram batch of blended resin was prepared containing: 84.1 wt % Petrothene® GA837091, 6.6 wt % of PM92973, and 9.3 wt % Starflex GM1835® (all available from Equistar Chemicals, LP) was prepared through twin screw compounding to produce a “Blend D.” The die temperature was 200° C. during compounding. No additional additives or stabilizers were introduced.

The ESCR of Blend D was tested by NCTL. In particular, a five notched tensile bar specimen of Blend D (according to ASTM D1822, type L) was loaded with 30% of yield strength (of the specimen) in 10% Igepal solution at 50° C. The sample was then monitored for a failure in an ESCR bath.

A portion of Blend D was applied to a wire as a coating. The wire coating extrusion was conducted on a 2.5 inch Davis-Standard line using a sleeve die with 4:1 draw-down on 14 AWG wire for a 30 mil insulation thickness. The line speed was set at 400 feet/minute.

Shrinkage measurements were performed on at least a portion of the wire coated with Blend D. The measurements were obtained by overnight aging (for 12 hours) a 10.0 inch long wire sample (without conduct) at ambient temperature. The 10.0 inch conditioned specimen was then further aged at 100° C. for 24 hours on a bed of talc. The shrinkage measurement was the changes in insulation length from 10.0 inches.

### Blend E:

A 2000 gram batch of blended resin was prepared containing: 81.7 wt % Petrothene® GA837091, 6.6 wt % of PM92973, and 11.7 wt % Starflex GM1835® (both available from Equistar Chemicals, LP) was prepared through twin screw compounding to produce a “Blend E.” The die temperature was 200° C. during compounding. No additional additives or stabilizers were introduced.

The ESCR of Blend E was tested by NCTL. In particular, a five notched tensile bar specimen of Blend E (according to ASTM D1822, type L) was loaded with 30% of yield strength (of the specimen) in 10% Igepal solution at 50° C. The sample was then monitored for a failure in an ESCR bath.

A portion of Blend E was applied to a wire as a coating. The wire coating extrusion was conducted on a 2.5 inch Davis-Standard line using a sleeve die with 4:1 draw-down on 14 AWG wire for a 30 mil insulation thickness. The line speed was set at 400 feet/minute.

Shrinkage measurements were performed on at least a portion of the wire coated with Blend E. The measurements were obtained by overnight aging (for 12 hours) a 10.0 inch long wire sample (without conduct) at ambient temperature. The 10.0 inch conditioned specimen was then further aged at 100° C. for 24 hours on a bed of talc. The shrinkage measurement was the changes in insulation length from 10.0 inches.

### Comparative A:

A 2000 gram batch of blended resin was prepared containing: 93.4 wt % of GA837 and 6.6 wt % of PM92973, commercially available from Equistar Chemicals, LP was used as Comparative A.

A portion of Comparative A was applied to a wire as a coating. The wire coating extrusion was conducted on a 2.5 inch Davis-Standard line using a sleeve die with 4:1 draw-down on 14 AWG wire for a 30 mil insulation thickness. The line speed was set at 400 feet/minute.

Shrinkage measurements were performed on at least a portion of a wire coated with Comparative A. The measurements were obtained by overnight aging (for 12 hours) a 10.0 inch long wire sample (without conduct) at ambient temperature. The 10.0 inch conditioned specimen was then further aged at 100° C. for 24 hours on a bed of talc. The shrinkage measurement was the change in insulation length from 10.0 inches.

### Comparative B:

Dow 8864BK, commercially available from Dow Chemical Company was used as Comparative B. The commercial Dow 8864BK product includes carbon black.

A portion of Comparative B was applied to a wire as a coating. The wire coating extrusion was conducted on a 2.5 inch Davis-Standard line using a sleeve die with 4:1 draw-down on 14 AWG wire for a 30 mil insulation thickness. The line speed was set at 400 feet/minute.

Shrinkage measurements were performed on at least a portion of a wire coated with Comparative B. The measurements were obtained by overnight aging (for 12 hours) a 10.0 inch long wire sample (without conduct) at ambient temperature. The 10.0 inch conditioned specimen was then further aged at 100° C. for 24 hours on a bed of talc. The shrinkage measurement was the changes in insulation length from 10.0 inches.

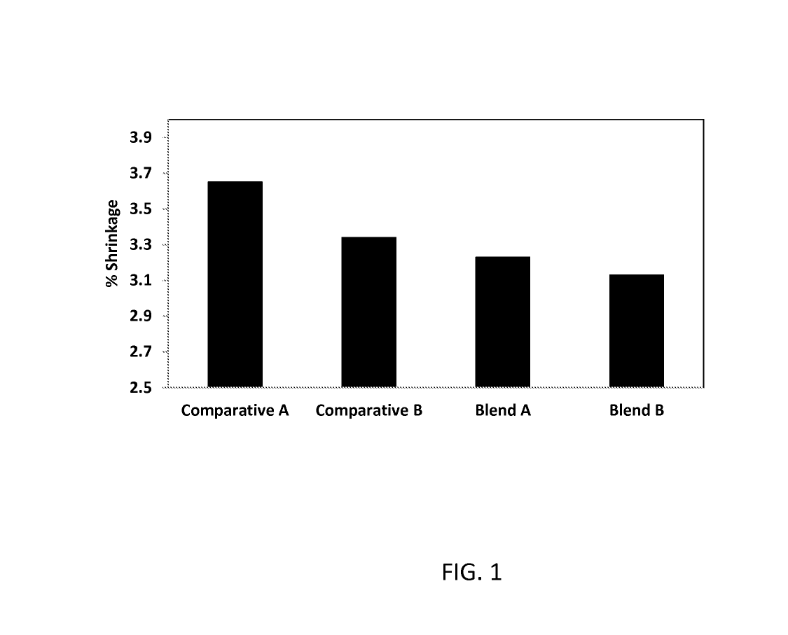

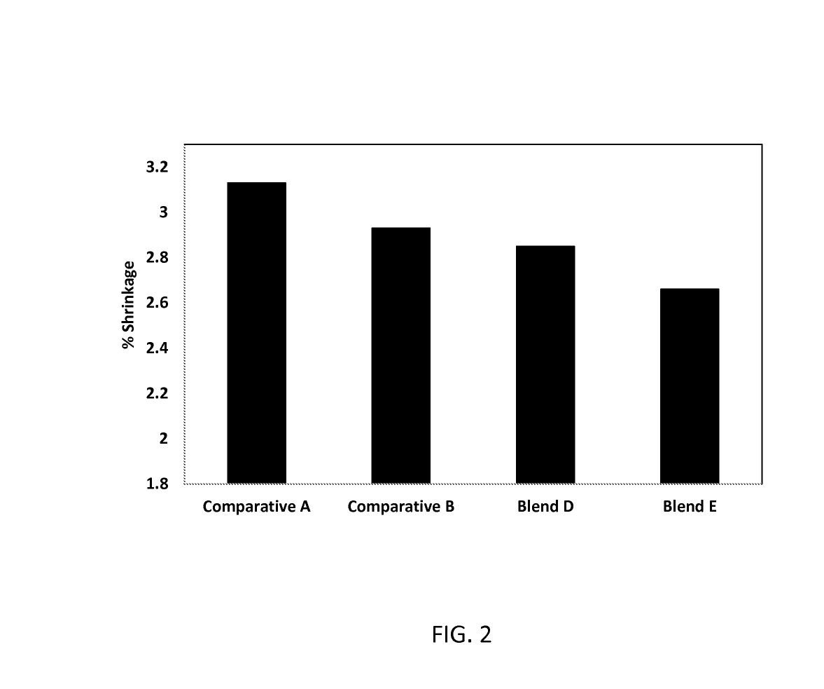

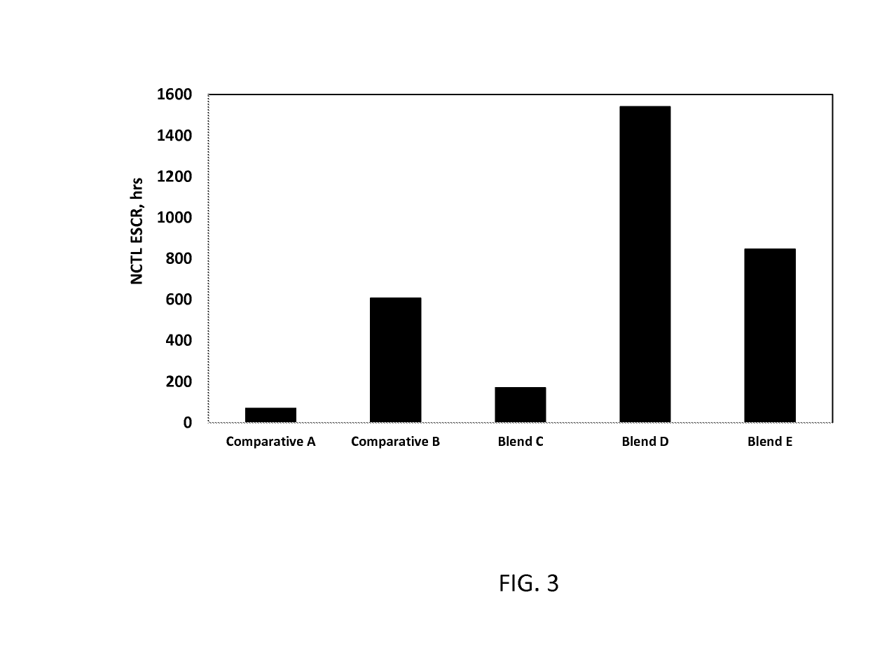

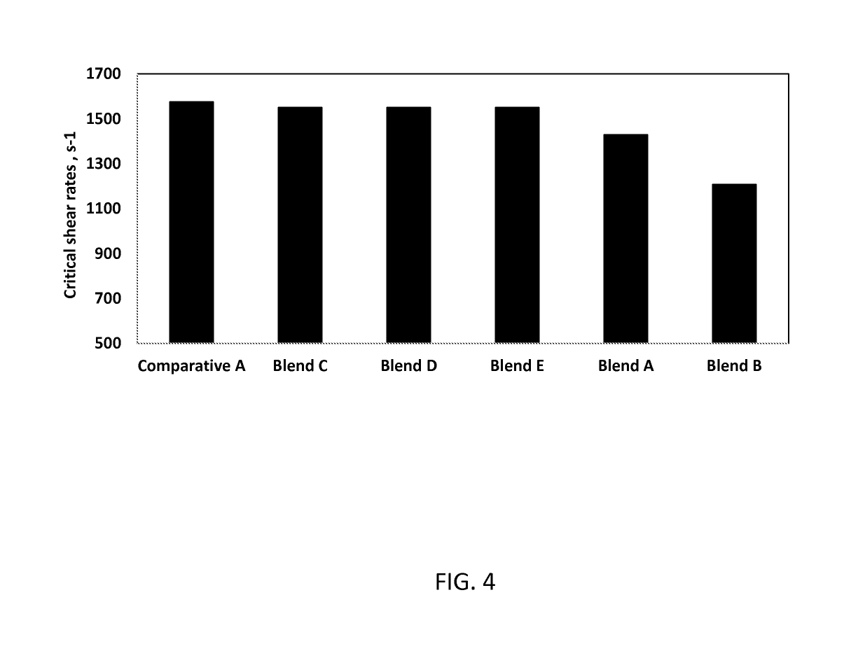

With reference to FIGS. 1 and 2, the results of the above-mentioned shrinkage measurement tests (in percent shrinkage) for comparative resins Comparative A and Comparative B, as well as inventive blend resins Blend A, Blend B, Blend D, and Blend E are provided. With reference to FIG. 3, the results of the above-mentioned NCTL ESCR tests (in hours) for comparative resins Comparative A and Comparative B, as well as inventive blend resins Blend C, Blend D, and Blend E are provided. With reference to FIG. 4, the results of the below-identified extrusion experiments used to assess the critical shear rate (“CSR”) (in 1/seconds) for comparative resin Comparative, as well as inventive blend resins Blend A, Blend B, Blend C, Blend D, and Blend E are provided.

Extrusion experiments in a Rosand capillary rheometer were used to assess the CSR for the onset of flow instabilities of blend compounds such as “shark-skin” and oscillating melt fracture. The capillary extrusion measurements were conducted at 190° C. through the die having a length/diameter of 18. The onset of “shark-skin” or oscillating melt fracture was determined from the pressure signal as well as from the alternate relatively smooth and distorted sections along the extrudates using visual inspection (by the naked, human eye). Without wishing to be bound by the theory, Applicant presently believes that the lower number of CSR indicates earlier onset of melt fracture during extrusion, which indicates a lower extrusion speeds of jacketing process: an undesirable result for commercial application. This means that the lower CSR, the higher probability of extrusion limitation. Without wishing to be bound by the summarization, a significant effect of extrusion limitation for blend compounds above 20% addition of GM1835 was observed. In various embodiments, the CSR, as tested by the method described above, of the blended polymer compositions described herein may ranging from about 1,300 to about 1,700 (1/s) or more; alternatively from about 1,400 to about 1,700 (1/s); alternatively from about 1,400 to about 1,600 (1/s); alternatively from about 1,450 to about 1,600 (1/s).

While specific alternatives to compositions and methods of the disclosure have been described herein, additional alternatives not specifically disclosed but known in the art are intended to fall within the scope of the disclosure. Thus, it is understood that other applications and embodiments of the present disclosure will be apparent to those skilled in the art upon reading the herein described embodiment and after consideration of the appended claims and any appended drawing figures.

What is claimed is:

1. A blended polymer composition comprising:
a polyethylene first resin having a density of at least 0.926 g/cm³; and
a mLLDPE resin having a density of between about 0.910 to about 0.925 g/cm³ and a melt index ranging between about 0.05 and about 5,
wherein the amount of the mLLDPE is less than about 20 weight percent based on the weight of the polyethylene first resin and the mLLDPE resin; and
wherein the mLLDPE resin has a narrower molecular weight distribution than the polyethylene first resin.

2. The blended polymer composition of claim 1, wherein the mLLDPE resin has a melt index ranging between about 0.05 and about 3.5.

3. The blended polymer composition of claim 1 having a density of about 0.935 g/cm³.

4. The blended polymer composition of claim 1 further comprising between about 1 weight percent and about 5 weight percent carbon black, based on the weight percent of the total polymer composition.

5. The blended polymer composition of claim 4 having about 2.6 weight percent carbon black, based on the weight percent of the total polymer composition.

6. The blended polymer composition of claim 1, wherein the blended polymer composition shrinks from about 0 percent to about 5%, as tested according to Procedure A.

7. The blended polymer composition of claim 6, wherein the jacket shrinks less than about 2.5% as tested according to Procedure A.

8. The blended polymer composition of claim 6, wherein the blended polymer composition has an NCTL ESCR of at least about 500 hours.

9. The blended polymer composition of claim 8, wherein the blended polymer composition shrinks less than about 5% as tested according to Procedure A.

10. The blended polymer composition of claim 1, wherein the mLLDPE resin has a polydispersity index ranging from about 1 to about 5 and the polyethylene first resin has a polydispersity index ranging from about 5 to about 20, wherein the polydispersity index of the mLLDPE is less than the polydispersity index of the polyethylene first resin.

11. The blended polymer composition of claim 1, wherein the CSR of the blended polymer ranges from about 1,300 1/s to about 1,700 1/s.

12. A jacketed wire or cable comprising:
a. a conductor or an optical fiber; and
b. a jacket disposed about at least a portion of the conductor or optical fiber, the jacket comprising:
i. a polyethylene first resin having a density of at least 0.926 g/cm³; and
ii. a mLLDPE resin having a density of between about 0.910 to about 0.925 g/cm³ and a melt index ranging from about 0.05 to about 5,
wherein the amount of the mLLDPE is less than about 20 weight percent based on the weight of the polyethylene first resin and the mLLDPE resin; and
wherein the mLLDPE resin has a narrower molecular weight distribution than the polyethylene first resin.

13. The jacketed wire or cable of claim 12, wherein the jacket has a thickness ranging from about 0.25 millimeters to about 2.5 millimeters and shrinks less than about 5% as tested according to Procedure A.

14. The jacketed wire or cable of claim 13, wherein the jacket shrinks less than about 2.5% as tested according to Procedure A.

15. The jacketed wire or cable of claim 12, wherein the jacket has an NCTL ESCR of at least about 500 hours.

16. The jacketed wire or cable of claim 15, wherein the jacket shrinks less than about 2.5% as tested according to Procedure A.

17. The jacketed wire or cable of claim 12, wherein the amount of the mLLDPE resin is about 12.5 weight percent based on the weight of the first polyethylene resin and the mLLDPE resin, and the melt index of the mLLDPE resin is about 3.5.

18. The jacketed wire or cable of claim 12 further comprising between about 1 weight percent and about 5 weight percent carbon black based on the weight percent of the total polymer composition.

19. The jacketed wire or cable of claim 18 having about 2.6 weight percent carbon black based on the weight percent of the total polymer composition.

20. The jacketed wire or cable of claim 12, wherein the mLLDPE resin has a polydispersity index ranging from about 1 to about 5 and the polyethylene first resin has a polydispersity index ranging from about 5 to about 20, wherein the polydispersity index of the mLLDPE is less than the polydispersity index of the polyethylene first resin.
